(19) United States
(12) Patent Application Publication
(10) Pub. No.: US 2003/0067459 A1
(43) Pub. Date: Apr. 10, 2003

(54) Apparatus and method for controlling convergence of projection TV

(75) Inventor: Nam-kyu Lim, Suwon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/218,579

(22) Filed: Aug. 15, 2002

(30) Foreign Application Priority Data
Oct. 4, 2001 (KR) 2001-61242

(51) Int. Cl. G09G 5/00

(52) U.S. Cl. 345/207

(57) ABSTRACT

Disclosed is an apparatus for controlling a convergence of a projection TV. The apparatus has: a pattern generation unit to generate a reference pattern; a detection unit to output a detection signal in response to the variation of luminance of the reference pattern; a reference voltage generation unit to output a reference pulse voltage in regard to colors of RGB; a comparison unit to output a comparison signal of a wave-form output from the detection unit in response to the luminance and the reference pulse voltage; and a microprocessor to calculate a gain deviation based on the comparison result of the comparison unit, and control RGB signals to compensate the luminance up and down. The detection unit comprised of a plurality of photo sensors disposed on the screen detects the luminance of the reference pattern, the comparison unit compares the detection wave-form of the detection unit and the reference pulse voltage, and determines that the output wave-form is above a reference level. The luminance gain is automatically controlled when an earth magnetic field is compensated as the gain deviation of the luminance is detected by counting the number of pulse wave-form above the reference level, and the RGB signals are controlled in response to the gain deviation of the luminance. Therefore, the malfunction of the apparatus for controlling a convergence, which is occurred due to the luminance deviation can be prevented.

### BACKGROUND OF THE INVENTION

1. Field of the Invention

The present invention relates to an apparatus and a method for controlling a convergence of a projection TV, and more particularly, to an apparatus and a method for controlling a convergence of a projection TV, which can prevent errors and malfunction caused by the characteristic of sensitivity for each color of a photo sensor when the convergence is controlled to compensate an earth magnetic field. The present application is based on Korean Patent Application No. 2001-61242, which is incorporated herein by reference.

2. Description of the Prior Art

A conventional projection TV using a CRT has a plurality of CRTs, projection lenses attached to a front side of the CRTs to project images, and a screen to compose the images projected from the projection lenses. Each CRT projects signals corresponding to each color of RGB (red, green, and blue) on the screen and expresses video signals to be seen.

To project a cathode ray exactly to a correct position on the CRT, a bias error of the cathode ray is adjusted by applying a magnetic field in a earth magnetic field at the position where the projection TV is actually placed and where the manufacturing line exists are sometimes different. Such variation of the magnitude of the earth magnetic field, which adjusts the bias error of the cathode ray, affects right forming of the images of the projection TV.

In other words, the differences of the earth magnetic field cause the distortion in the bias error of the cathode ray. Thus, the images are not accurately formed on the CRT screen. Accordingly, to compensate the earth magnetic field different at the positions, the projection TV has a built-in convergence controlling apparatus to compensate the effect of the earth magnetic field.

FIG. 1 is a view describing a conventional way of controlling a convergence. FIG. 2 is a block diagram showing a controlling apparatus of a conventional projection TV.

As shown in FIG. 2, the projection TV has a screen 10 to display the images, a CRT 70 to form an image on the screen 10 by reproducing the video signals, a RGB signal control unit 60 to control the video signals to be transmitted to the CRT 70, and a convergence control unit 40 to adjust the bias of the cathode ray due to the earth magnetic field.

Moreover, the projection TV comprises a pattern generation unit 50 to generate reference patterns on the screen for compensating the convergence, photo sensors S1, S2, S3 and S4 disposed on the screen in order to sense the luminance of reference patterns, and a micro-processor 30 to control the convergence control unit 40 by judging the bias degree of the convergence in response to output signals of the photo sensors S1, S2, S3 and S4.

The projection TV having the above structure controls the convergence by using the way described in FIG. 1 to compensate the bias of the convergence. In other words, predetermined reference patterns P_{V} and P_{H} are displayed on the screen 10 of the projection TV to determine the degree of bias of the cathode ray, and the plurality of photo sensors S1, S2, S3 and S4 are disposed at the case of the screen 10. The reference patterns P_{V} and P_{H} move on the screen 10, and the photo sensors S1, S2, S3 and S4 measure the luminance of the reference patterns P_{V} and P_{H} and output a detection waveform in proportion to the luminance.

The detection wave-form in accordance with the detection result of the luminance of a vertical reference pattern P_{V} should have a maximum value at a set-up position x1 of the sensor S1 that is input and set in the microprocessor 30 of the projection TV. However, when the projection TV is placed at a different place from the manufacturing line, the magnitude of the magnetic field is differentiated due to changes in the earth magnetic field. Thus, the output value of the sensor S1 is the maximum value at the position of the reference pattern PV deviated to a position of x1+Δx. The microprocessor 10 of the projection TV determines the magnitude of the earth magnetic field at a corresponding position by using the deviated value Δx, and compensates the bias error of the convergence based on the result. Therefore, images are accurately formed on the screen. The horizontal reference pattern P_{H} also compensates the convergence with the same method above.

However, when the earth magnetic fields is compensated by using the above-described conventional way of controlling the convergence, malfunction or errors can be occurred due to the deviation of the luminance gain of the photo sensor.

A wavelength of the light is different in accordance with the colors, RGB, and the deviation of the luminance sensed by the photo sensors are great according to the wavelength. In the case of a BLUE light having a short wavelength, the difference of the output gain is great. Yet, in the case of a RED light having a long wavelength, it is opposite. Thus, even though the sensor is sensing the RED light, an error message showing that the sensor is not working might be output.

In other words, there are problems in compensating the earth magnetic field for forming accurate images, which are malfunction or errors of the apparatus for controlling the convergence in accordance with a mechanical deviation or the gain deviation of the reference patterns different for the sensors.

### SUMMARY OF THE INVENTION

The present invention has been made to overcome the above-mentioned problem of the prior art. Accordingly, it is the object of the present invention to provide an apparatus and a method for controlling a convergence of a projection TV, which can prevent a malfunction of the apparatus for controlling the convergence due to a gain deviation of a luminance detected by a photo sensor when an earth magnetic field is automatically compensated.

The apparatus for controlling the convergence of the projection TV according to the present invention comprises: a pattern generation unit to generate a predetermined reference pattern displayed on a screen; a detection unit to detect change of luminance of the reference pattern while the reference pattern is moving on the screen; a reference voltage generation unit to output a reference pulse voltages in regard to each one of RGB colors respectively; a comparison unit to compare an output voltage of the detection unit and the reference pulse voltage; and a microprocessor to detect as gain deviation of the luminance based on a result of the comparison unit, and control RGB signals to compensate the luminance in response to the gain deviation.

The detection unit includes: a plurality of photo sensors to detect the luminance while the reference pattern is moving on the screen; and a switching unit to connect an output signal of a photo sensor to detect the luminance variation among the plurality of photo sensors to the comparison unit. The reference voltage generation unit includes: a PWM wave-form generator to output a PWM wave-form in response to control of the microprocessor; a switch to control the PWM wave-form to a pulse-type wave-form; a PWM voltage transformer to transform a width of a pulse voltage in response to the colors of RGB; and a DC converter to convert the pulse-type wave-form to a direct current having a voltage width set-up at the PWM voltage transformer and input the direct current into the comparison unit.

In the meantime, according to the present invention, the method of controlling a convergence of a projection TV comprises the steps of: generating a reference pattern moving on a screen; detecting luminance variation while the reference pattern is moving on the screen; calculating a compensation value of a gain deviation of the luminance of the reference pattern in response to the degree of the luminance variation: and controlling RGB signals to change the luminance of the reference pattern in response to the compensation value.

Here, the calculating step includes the step of: comparing a luminance detection signal detected in the detecting step and a reference voltage; outputting a high signal when the detection signal is above the reference voltage; counting the number of high signals; calculating the compensation value in accordance with the number of high signals.

According to the present invention, the malfunction of the apparatus for controlling the convergence can be prevented when the earth magnetic field of the convergence TV is compensated as the gain deviation of the luminance is controlled.

### BRIEF DESCRIPTION OF THE DRAWINGS

The above-mentioned object and the feature of the present invention will be more apparent by describing the preferred embodiment of the present invention by referring to the appended drawings, in which:

FIG. 1 is a view showing a screen displaying reference patterns output to compensate an earth magnetic field of a conventional projection TV;

FIG. 2 is a block diagram schematically showing an apparatus for controlling a convergence of a conventional projection TV;

FIG. 3 is a block diagram showing one preferred embodiment of an apparatus for controlling a convergence of a projection TV according to the present invention; and

FIG. 4 is a flow chart showing a method of controlling a convergence according to the present invention.

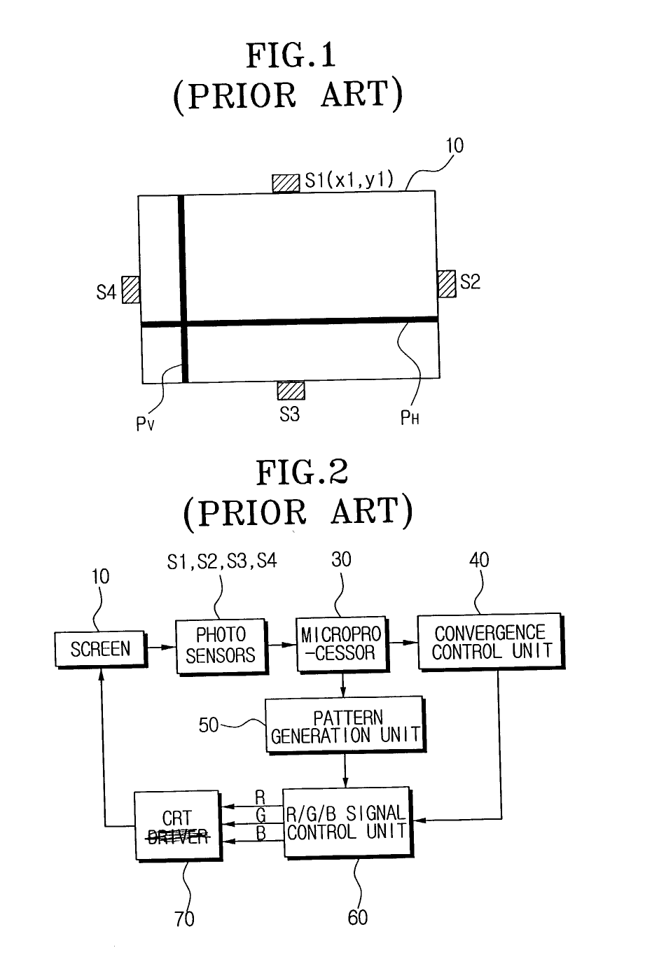

### DESCRIPTION OF THE PREFERRED EMBODIMENT

Hereinbelow, the present invention will be described in greater detail by referring to the appended drawings.

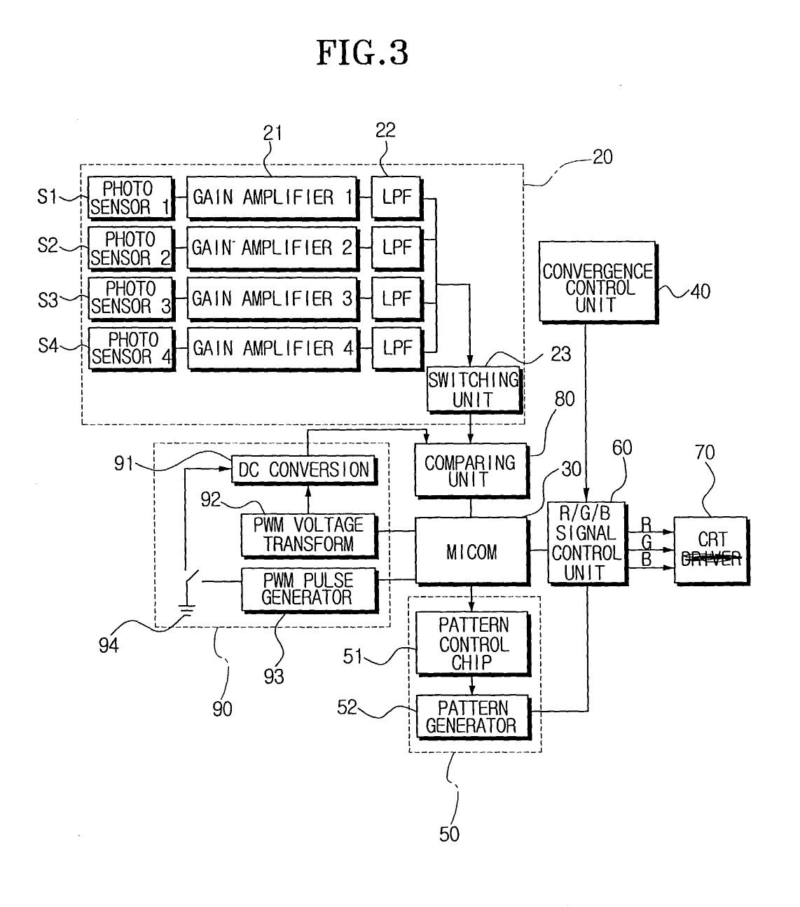

FIG. 3 is a block diagram one preferred embodiment of an apparatus for controlling a convergence of a projection TV according to the present invention. As shown in FIG. 3, the projection TV has a CRT 70 to reproduce video signals and from images, an RGB signal control unit 60 to control RGB signals transmitted to the CRT 70, a screen (not shown) to display the formed images on the CRT 70, and a convergence control unit 40 to control deviation of a cathode ray.

In addition, the projection TV has a reference pattern generation unit 50 to generate reference patterns on the screen, a detection unit 20 to detect the luminance of reference patterns moving on the screen and output a voltage in proportion to the luminance, a reference voltage generation unit 90 to output a reference pulse voltage in response to the colors of RGB, a comparison unit 80 to compare a voltage output from the detection unit 80 and the reference pulse voltage, and a microprocessor 30 to detect a luminance gain deviation based on a result of the comparison unit 80 and control RGB signals to compensate the luminance in response to the detection result.

The reference pattern generation unit 50 comprises a pattern generator 52 to output a reference pattern signal moving on the screen, and a pattern control chip 51 to control the pattern generator 52 to output reference patterns to allow photo sensors S1, S2, S3, and S4 to easily sense the reference patterns in accordance with signals input from the microprocessor 30.

The detection unit 20 comprises four photo sensors S1, S2, S3 and S4 disposed on the screen of the projection TV in order to output detection signals in response to the luminance of the reference patterns moving on the screen to control the convergence, a gain amplifier 21 to amplify a wave-form output from the photo sensors S1, S2, S3 and S4, a low-pass filter 22 to remove noise from output signals of the gain amplifier 21, and a switching unit 23 to select a sensor to detect the luminance deviation among the photo sensors S1, S2, SS3 and S4.

The reference pattern generation unit 90 to output a reference pulse voltage compared to the output wave-form of the detection unit 20 comprises PWM wave-form generator 93 to output a PWM wave-form in accordance with the control of the microprocessor 30, a switch 94 to control the PWM wave-form to a pulse-type wave-form, a PWM voltage transformer 92 to transform a width of the pulse voltage in accordance with the color of RGB, and a DC converter 91 to convert the pulse-type PWM wave-form into a direct current.

The comparison unit 80 compares the detection wave-form input from the detection unit 20 and the reference pulse voltage and outputs a high signal when the detection wave-from is above the reference pulse voltage, and outputs a low signal when the detection wave-form is below the reference pulse voltage to the microprocessor 30.

The microprocessor 30 counts the number of high signals among the signal input from the comparison unit 80. In addition, the microprocessor 30 determines the compensation degree of the luminance in accordance with the counted number of high signals and calculates a compensation value of the luminance gain deviation.

Furthermore, the microprocessor 30 outputs a control signal to the RGB signal control unit 60 in response to the compensation value and changes the luminance so that the luminance gain deviation can be compensated.

The compensation value of the luminance gain deviation is stored in E2PROM (not shown). Moreover, the detection wave-form of the detection unit 20 is input into the convergence control unit 40 and the deviation degree of the earth magnetic field is detected. Accordingly, the deviation degree of the CRT is adjusted.

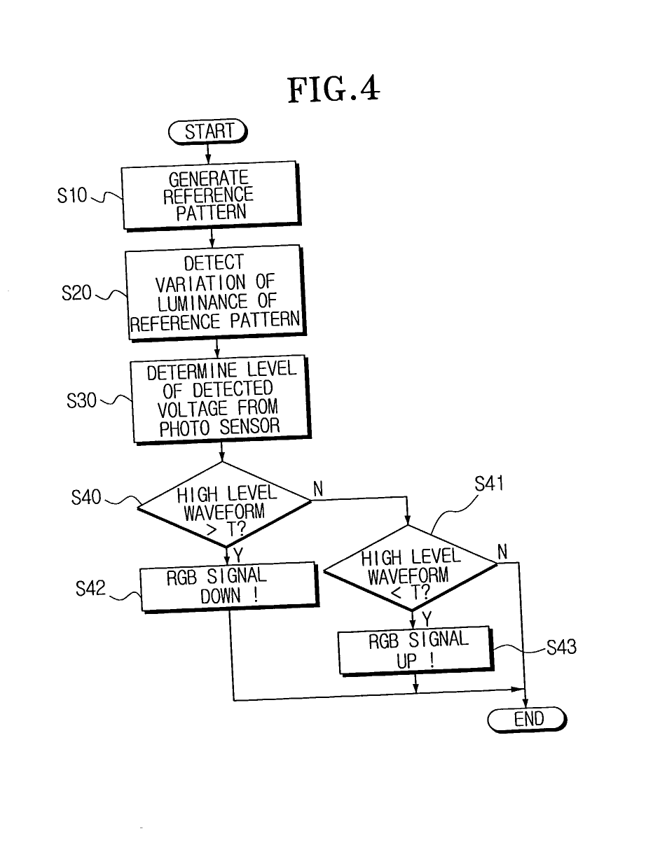

Hereinbelow, the method of controlling the convergence according to the present invention will be described referring to FIG. 4.

When the power is supplied to the projection TV, the method of controlling the convergence is operated before a selected broadcasting signal is output on the CRT 70. The control of the convergence can be designed to operate when a separate command for controlling the convergence is input by a user.

When an automatic convergence adjusting mode is operated, the microprocessor 30 generates the reference patterns on the screen by driving the pattern generation unit 50 (S10). In other words, the microprocessor 30 outputs the control signal to generate the reference patterns suitable to the color of RGB to the reference pattern control chip 51. The reference control chip 51 controls the reference pattern generator 52 in response to the control signal and generates a corresponding reference pattern. The reference patterns are pattern signals such as a square-shaped window pattern or a straight-line pattern to allow the photo sensors S1, S2, S3 and S4 to easily detect.

The generated reference patterns move on the screen up, down, right, and left within a range that the photo sensors S1, S2, S3 and S4 can detect. The luminance of the reference patterns moving on the screen is detected by the photo sensors S1, S2, S3 and S4 disposed on the screen (S 20). The photo sensors S1, S2, S3 and S4 output detection signals in proportion to the luminance. The detection signals output from the photo sensors S1, S2, S3 and S4 are amplified at the gain amplifier 21 and the low-pas filter 22 removes noise from the detection signals. An output signal of a photo sensor selected by the switching unit 23 among the signals passed through the low-pass filter 22 is allowed to the comparison unit 80. A peak wave-form is detected centering the position of the photo sensors S1, S2, S3 and S4 from the output signals.

To generate the reference pulse voltage, the microprocessor 30 allows signal corresponding to the colors of RGB to the PWM voltage transformer 92 and the PWM wave-form generator 93. The PWM wave-form generator 93 outputs a PWM wave-form suitable to control the luminance. The PWM wave-form is converted into the pulse-type wave-form in accordance with switching and allowed to the DC converter 91. The PWM voltage transformer 92 converts the width of the pulse according to the color of RGB. The pulse-type wave-form allowed to the DC converter 91 is converted into a reference direct current and input to the comparison unit 80.

The comparison unit 80 compares the detection signals output from the detection unit 80 and the reference pulse voltage and determines the level of the detection signals (S 30). In other words, the reference pulse voltage in response to the colors of RGB and the detection signals output from the detection unit 20 are input into the comparison unit 80. The comparison unit 80 compares the reference pulse voltage input from the DC converter 91 and the detection signals input from the detection unit 20 and outputs the high signal when the detection voltage is above the reference pulse voltage, and outputs the low signal when the detection voltage is below the reference pulse voltage to the microprocessor 30.

The microprocessor 30 counts the number of high signals and calculates the gain deviation compensation value matching with the counted number in accordance with database set up in advance (S 40 and S 41). The microprocessor 30 controls the RGB signal control unit 60 so that the luminance can be changed according to the calculated compensation value (S 42 and S 43). In other words, when the high signals are above a predetermined number, the luminance of the reference pattern is down for a predetermined range by removing the RGB signal in order to compensate the luminance gain deviation. When the high signals are below the predetermined number, the luminance of the reference pattern is up. The compensation value of the gain deviation is output to the RGB control unit 60 connected with the microprocessor through IIC communication and automatically controls the luminance deviation by the IIC communication.

The compensation value of the luminance output gain deviation is stored into the E2PROM. After the luminance deviation is compensated, the reference patterns P_{V} and P_{H} are generated. Moreover, the luminance of the reference patterns P_{V} and P_{H} is detected at the detection unit 20 and the convergence is controlled in accordance with the detection signals. The convergence is controlled after the luminance deviation is compensated. Therefore, the malfunction or the errors of the controlling apparatus, which are caused by the deviation of the luminance gain of the reference patterns different for the sensors or the mechanical deviation can be prevented.

Following is one example of controlling the luminance gain deviation of the RED light.

First of all, when the microprocessor 30 inputs a signal to generate the reference pattern for RED adjustment into reference pattern control chip 51, a reference pattern suitable for the RED light is generated from the reference pattern generator 52 by the control of the control chip 51. The reference pattern is moved up, down, right, and left in response to the position of the photo sensor having a low RED gain (set up in advance by an experiment). The microprocessor 30 selects a sensor to detect the luminance deviation by controlling the switching unit 23, and allows the detection signal output from the selected photo sensor to the comparison unit 80. The detection signal forms the peak wave-form centering the position of the photo sensor.

On the other hand, a corresponding PWM pulse-type wave-form is generated so that the reference pulse voltage corresponding to the RED light can be allowed to the comparison unit 80. The PWM wave-form is converted into the direct current at the DC converter 91 and input into the comparison unit 80. The comparison unit 80 compares the detection signal of the detection unit 20 and the reference pulse voltage. When the detection signal is above the reference pulse voltage, the high signal is output, and the detection signal is below the reference pulse voltage, the low signal is output. The microprocessor 30 counts the pulse signal output from the comparison unit 80, and calculates the compensation value of the luminance gain in accordance with the number of counted high signals. The compensation value of the gain deviation is set up according to the number of high signal through an experiment, and stored into the microprocessor 30 in advance. The luminance of the RED light is changed as the RGB signal control unit 60 controls the signal of the RED light in accordance with the calculated compensation value of the luminance gain. Accordingly, the luminance deviation is adjusted and the gain of the photo sensors are constant.

When the luminance deviation is adjusted as described above, the reference patterns are again generated. Thus, the detection unit 20 measures the changes of the luminance in response to the movement of the reference patterns without the luminance gain deviation. The detection signal of the detection unit 20 is output to the convergence control unit 40 and the control of the convergence to compensate the earth magnetic field is operated.

According to the present invention, the convergence is compensated after the luminance deviation is compensated in order to the gain output of the photo sensors by the luminance deviation is constant. Thus, the earth magnetic field compensation is made at an optimum extent, and the malfunction of the apparatus for controlling the convergence can be prevented.

Although the preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited within the described range but the following claims.

What is claimed is:

1. An apparatus for controlling a convergence of a projection TV comprising:
a pattern generation unit to generate a reference pattern displayed on a screen;
a detection unit to detect variation of luminance of the reference pattern while the reference pattern is moving on the screen;
a reference voltage generation unit to output a reference pulse voltage in regard to colors of RGB;
a comparison unit to compare an output voltage of the detection unit and the reference pulse voltage; and
a microprocessor to calculate a gain deviation based on the comparison result of the comparison unit, and control RGB signals to compensate the luminance according to the gain deviation.

2. The apparatus for controlling a convergence of a projection TV of claim 1, wherein the detection unit includes:
a plurality of photo sensors to detect the luminance while the reference pattern is moving on the screen; and
a switching unit to select a photo sensor to detect the variation of luminance out of the plurality of photo sensors.

3. The apparatus for controlling a convergence of a projection TV of claim 1, wherein the reference voltage generation unit includes:
a PWM wave-form generator to output a PWM wave-form under a control of the microprocessor;
a switch to control the PWM wave-form to a pulse-type wave-form;
a PWM voltage transformer to transform a width of a voltage of the pulse type waveform in response to the colors of RGB; and
a DC converter to convert the pulse-type wave-form into a direct current having a voltage width set-up at the PWM voltage transformer and input the direct current into the comparison unit

4. A method of controlling a convergence of a projection TV comprising the steps of:
generating a reference pattern moving on a screen;
detecting a variation of luminance while the reference pattern in moving;
calculating a compensation value for a gain deviation of the luminance of the reference pattern in response to the variation of luminance; and
controlling RGB signals to change the luminance of the reference pattern in response to the compensation value.

5. The method of controlling a convergence of a projection TV of claim 4, wherein the calculating step includes the steps of:
comparing a luminance detection signal detected in the detecting step and a reference voltage;
outputting a high signal when the detection signal is above the reference voltage;
counting the number of high signals; and
calculating the compensation value in accordance with the number of high signals.
